(19) United States
(12) Patent Application Publication
(10) Pub. No.: US 2007/0204768 A1
(43) Pub. Date: Sep. 6, 2007

(54) Antiskid Handling Device

(75) Inventors: Weidong Li, Verneuil Sur Seine (FR); Matthieu Giletti, Franqueville Saint Pierre (FR)

Correspondence Address: YOUNG & THOMPSON, 745 SOUTH 23RD STREET, 2ND FLOOR, ARLINGTON, VA, 22202, US

(73) Assignee: ALLIBERT EQUIPMENT, NANTERRE (FR)

(21) Appl. No.: 10/593,636

(22) PCT Filed: Mar. 2, 2005
(86) PCT No.: PCT/FR05/00497

§ 371 Date: Sep. 21, 2006

(30) Foreign Application Priority Data
Mar. 23, 2004 (FR) 04/02984

(51) Int. Cl. B65D 19/38; B29C 45/16

(52) U.S. Cl. 108/57.25

(57) ABSTRACT

The invention relates to a handling device (10) which is made of a plastic material, comprises at least one contact part consisting of an external antiskid contact area (18) and a rigid area (20), wherein the contact part is made of only one composite plastic material which consists of a mixture of at least one antiskid component having viscosity V1 at the injection temperature with a rigid component which is physico-chemically compatible with the antiskid component and has a viscosity V2 at the injection temperature and the viscosity V1 is less than the viscosity V2 in such a way that the antiskid component concentration in the external antiskid area (18) is greater than the concentration thereof in the rigid area (20).

In order to store, handle and transport objects, it is known to use pallets, boxes and containers. The pallets may be of wood and the boxes and the containers of cardboard. It is thus possible to stack empty pallets or boxes on pallets. It is further possible to transport pallets using a fork-lift truck and store them on horizontal metal racks.

This solution is satisfactory in terms of the stability of the loads transported. The friction coefficient between the pallet and the boxes is sufficient to prevent the boxes from slipping on the plate of the pallet when being handled, in particular by a lifting truck.

However, a pallet is limited to being used a few tens of times and a box can be used only once.

Furthermore, wood cannot be used for all types of application, for example, in food industries.

Cardboard also has limitations, in particular for handling heavy or wet loads.

It is also known to use containers and pallets of plastics material, such as high-density polyethylene (HDPE). This solution has a number of advantages.

They are rigid, strong, hygienic, non-decomposable, resistant to differences in hygrometry and can consequently be reused a very large number of times compared with similar products of wood or cardboard.

However, the plastics material used for this type of product has a lower friction coefficient than that of wood or cardboard. This can present problems. In particular when a container is stored on a pallet, it is necessary to provide retaining means, such as retaining studs or rims, otherwise there is a risk of the container slipping when the pallet is handled. A similar problem in terms of slipping can occur during handling with a fork-lift truck, storage on a rack or when stacking one pallet on top of another.

In order to overcome these problems, it is known to produce anti-skid zones on the upper face of the plate of the pallet.

It is known to form rough portions which in particular allow cardboard boxes to be fixed or projections which allow containers to be wedged. Solutions of this type are not ideal since, for example, a pallet comprising rough portions will not be able to be used for receiving containers of plastics material, at the risk of further increasing the slipping action. The wedges are suitable for containers having predetermined dimensions which restricts the user to using one type of container with one type of predetermined pallet and limits the multi-purpose nature of the products.

It is also possible to attach or to overmould an element which has a friction coefficient greater than that of the material which constitutes the plate.

However, solutions of this type are not satisfactory. The anti-skid element may become detached from the pallet; furthermore, the production time and the cost of machining are increased.

In order to provide a solution to these problems, the invention proposes a handling device of plastics material, comprising at least one contact portion which is constituted by an anti-skid outer contact zone and a rigid zone, characterised in that the contact portion is produced from a single composite plastics material which is constituted by the mixture of at least one anti-skid component having a viscosity V1 at the injection temperature and a rigid component which is physico-chemically compatible with the anti-skid component and which has a viscosity V2 at the injection temperature, and in that the viscosity V1 is lower than the viscosity V2 so that the anti-skid outer zone comprises a higher concentration of anti-skid component than the rigid zone.

The handling device thus has a level of rigidity and strength close to that of the rigid material whilst having an anti-skid outer zone which allows the slipping action to be limited between the handling device and the element which it receives or which supports it.

According to other features of the invention:
the flexible component is a thermoplastic elastomer;
the rigid component is of polyethylene;
the plastics material comprises at least one additional reinforcement component, such as talcum or fibres.

The invention also proposes a handling pallet of the type described above, characterised in that the contact portion is the upper plate.

According to other features of the invention:
the contact portion is a base plate.

The invention also proposes a handling container of the type described above, characterised in that the contact portion is the base wall of a handling container.

The invention further proposes a movable carriage of the type described above, characterised in that the contact portion is the upper plate.

Other features and advantages of the invention will be appreciated from a reading of the detailed description below, for the better understanding of which reference will be made to the appended drawings, in which:

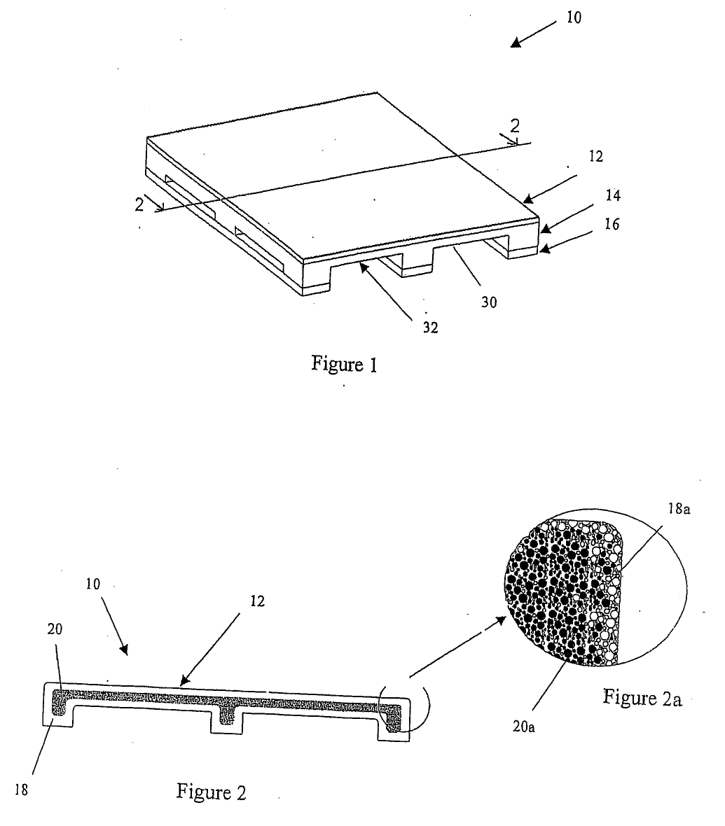

FIG. 1 is a schematic perspective view of a handling pallet produced according to the invention;

FIG. 2 is a sectioned view of the upper plate of a handling pallet, taken along the vertical plane which extends via the line 2-2 illustrated in the preceding Figure;

FIG. 2a is a sectioned detailed view of the upper plate of a handling pallet illustrated in the preceding Figure;

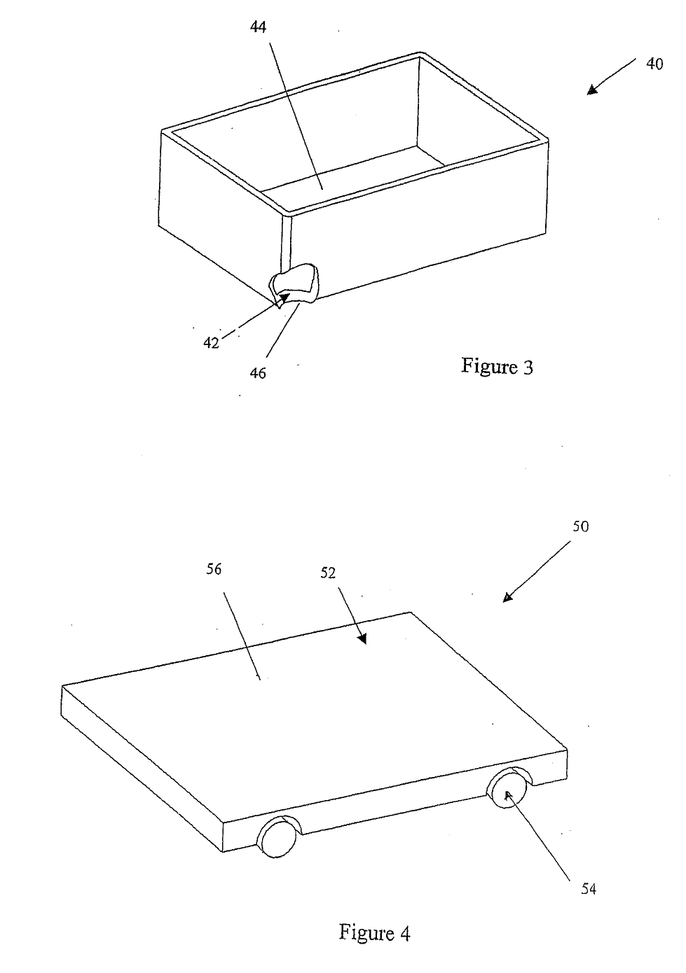

FIG. 3 is a schematic perspective view of a handling container produced according to the invention;

FIG. 4 is a schematic perspective view of a movable carriage produced according to the invention.

FIG. 1 illustrates a handling pallet 10 which is produced by injecting plastics material into a mould.

The pallet 10 is constituted by an upper plate 12, an intermediate body 14 and base plates 16.

These three elements can be produced in three separate parts, these parts being assembled together, in accordance with FIG. 1, using a known method, such as welding with heat reflectors. They can also be produced in one piece so as to form a unitary pallet.

The upper plate 12 is intended to receive a load such as handling containers (not illustrated).

The pallet 10 comprises at least one contact portion which, by way of example, is the upper plate 12.

The contact portion is constituted by an anti-skid outer contact zone 18 and a rigid zone 20.

According to the invention, the contact portion is produced from a single composite plastics material which is constituted by the mixture of at least one anti-skid component (illustrated in a schematic manner by white circles 18a in FIGS. 2 and 2a) which has a viscosity V1 at the injection temperature and an anti-skid rigid component (illustrated in a schematic manner by black discs 20 in FIGS. 2 and 2a) which is physico-chemically compatible with the anti-skid component and which has a viscosity V2 at the injection temperature. The viscosity V1 is lower than the viscosity V2 so that the anti-skid outer zone comprises a higher concentration of anti-skid component than the rigid zone.

By way of non-limiting example, V2 is selected to be substantially equal to 7 V1.

When the mould is filled with the material, since the viscosity V1 of the anti-skid component is lower than the viscosity V2 of the rigid component, the anti-skid component will preferentially be against the walls of the mould and will then solidify.

According to FIGS. 2 and 2a, the concentration of anti-skid component is therefore higher in the proximity of the wall of the mould, that is to say, the anti-skid outer zone 18. The rigid component is located mostly at the centre of the plate 12, in accordance with FIG. 2.

The invention thus allows a handling device to be produced which has a robust and effective anti-skid zone, without changing the moulding tools and increasing the injection cycle time.

The two anti-skid and rigid components are physico-chemically compatible which allows them to have a good level of cohesion. The anti-skid zone and the rigid zone are thus closely linked which eliminates the risk of two zones becoming separated.

According to a variant which is not illustrated, the contact portion is limited to a region of the upper plate 12.

To this end, the plate is injected into a mould by means of a plurality of injectors, some of which are supplied with the composite plastics material, others with a conventional plastics material, such as HDPE, which is chemically compatible with the composite material.

In order to limit the contact portion, it is also possible to control the temperature of specific zones of the mould. Since the anti-skid component has a viscosity V1 lower than the viscosity V2 of the rigid component, it is possible, by producing mould zones which are colder than others, to increase the concentration of anti-skid component in the proximity of these zones.

By way of example, the anti-skid zones 18 can have a circular or oblong shape.

Solutions of this type allow the consumption of composite material to be optimised and allow the levels of anti-skid effectiveness to be adapted to the requirements defined by the user of the pallet.

In order to increase the strength and the rigidity of the handling device, the invention proposes that the plastics material comprise at least one additional reinforcement component. By way of non-limiting example, the additional component is talcum or glass fibres.

In order to further increase the rigidity of the pallet, it can be envisaged to reinforce it in known manner using reinforcement elements, such as metal tubes, which are inserted in the upper plate.

The rigid component can be part of the polyolefine group, it is advantageously polyethylene, in particular HDPE.

The anti-skid component has a friction coefficient greater than that of the rigid component. It is advantageously part of the thermoplastic elastomer group and is physico-chemically compatible with the rigid component.

By way of example, the rigid component and the anti-skid component are selected so that the relationship between their flexure modulus is 100. The flexure modulus of the rigid component can thus be in the order of from 1000 to 1200 MPa and that of the anti-skid component in the order of from 10 to 12 MPa.

The contact portion can also be a base plate 16 of the handling pallet 10. In this manner, when the pallet is placed on a support, such as another pallet or storage racks, the stability thereof is greatly improved.

A contact portion can also be located below the lower plate 30 of the intermediate body 14 in the region of the fork passages 32. When the pallet is displaced on the forks of a lifting truck, the presence of the anti-skid outer zone allows the slipping of the pallet to be limited. The accelerations and the displacement speed of the carriage can be higher, which allows the time and the cost of handling the pallets to be optimised.

The handling device can also be a handling container 40, and the contact is advantageously the base wall 42. The upper face 44 and lower face 46 of the base wall have anti-skid characteristics.

Objects which are stored on the upper face 44 of the container 40 are more stable and the impacts with the lateral walls are limited.

The increase of the adhesion of the lower face 46 allows the container to be stabilised when it is placed on a support, such as a pallet, a table but also a conveyor. In this instance, the contact portion allows the guiding of the container to be facilitated and allows the transport speed to be increased.

In a similar manner to pallets, it is possible to limit the contact portion to a region, in accordance with the use of the container.

For use on a conveyor, it is necessary for the level of adhesion of the lower face 46 to be as high as possible. The anti-skid outer zone of the contact portion is advantageously limited to the lower face and in particular the zones in contact with the driving devices of the conveyor. This is obtained, for example, by a difference in temperature between the wall of the mould which is in contact with the lower face 46 and the wall of the mould in contact with the upper face 44.

The handling device can also be a movable carriage 50 constituted by an upper plate 52 and wheels 54. The contact portion is advantageously the upper face 56 of the plate 52 of the carriage. This allows the transported load to be stabilised.

1. Handling device (10) of plastics material, comprising at least one contact portion which is constituted by an anti-skid outer contact zone (18) and a rigid zone (20), characterised in that the contact portion is produced from a single composite plastics material which is constituted by the mixture of at least one anti-skid component (18a) having a viscosity V1 at the injection temperature and a rigid component (20a) which is physico-chemically compatible with the anti-skid component (18a) and which has a viscosity V2 at the injection temperature, and in that the viscosity V1 is lower than the viscosity V2 so that the anti-skid outer zone (18) comprises a higher concentration of anti-skid component than the rigid zone (20).

2. Handling device (10) according to claim 1, characterised in that the anti-skid component (18a) is a thermoplastic elastomer.

3. Handling device (10) according to claim 1, characterised in that the rigid component (20a) is of polyethylene.

4. Handling device (10) according to claim 1, characterised in that the plastics material comprises at least one additional reinforcement component, such as talcum or fibres.

5. Handling pallet (10) according to claim 1, characterised in that the contact portion is the upper plate (12).

6. Handling pallet (10) according to claim 1, characterised in that the contact portion is a base plate (16).

7. Handling container (40) according to claim 1, characterised in that the contact portion is the base wall (42).

8. Movable carriage (50) according to claim 1, characterised in that the contact portion is the upper plate (52).

9. Handling device (10) according to claim 2, characterised in that the rigid component (20a) is of polyethylene.

10. Handling pallet (10) according to claim 2, characterised in that the contact portion is the upper plate (12).

11. Handling pallet (10) according to claim 2, characterised in that the contact portion is a base plate (16).

12. Handling container (40) according to claim 2, characterised in that the contact portion is the base wall (42).

13. Movable carriage (50) according to claim 2, characterised in that the contact portion is the upper plate (52).
